(19) United States
(12) Patent Application Publication
(10) Pub. No.: US 2017/0017105 A1
(43) Pub. Date: Jan. 19, 2017

(54) DISPLAY PANEL AND MANUFACTURING METHOD THEREOF

(71) Applicant: SHENZHEN CHINA STAR OPTOELECTRONICS TECHNOLOGY CO. LTD., GUANGDONG (CN)

(72) Inventors: Yanxi YE, GUANGDONG (CN); Yunglun LIN, GUANGDONG (CN); Zhuming DENG, GUANGDONG (CN); Chunkai CHANG, GUANGDONG (CN)

(21) Appl. No.: 14/777,750

(22) PCT Filed: Jul. 30, 2015
(86) PCT No.: PCT/CN2015/085541

§ 371 Date: Sep. 17, 2015

(30) Foreign Application Priority Data
Jul. 16, 2015 (CN) 201510417193.5

(51) Int. Cl. G02F 1/1339; G02F 1/1362; G02F 1/1335; G02F 1/1368

(52) U.S. Cl. CPC G02F 1/13394; G02F 1/1368; G02F 1/136286; G02F 1/133512; G02F 2001/136222; G02F 2201/123

(57) ABSTRACT

A display panel and a manufacturing method thereof are provided. The display panel has a first display area, a second display area, and a non-display. A color film of the first display area has a first color barrier corresponding to the first display area, and a second color barrier corresponding to the second display area. A first light shielding block of the first panel corresponds to the non-display area. A second light shielding block of the second panel corresponds to the non-display area. The present invention can prevent the light leakage problem of the display panel.

### FIELD OF THE INVENTION

The present invention relates to a technical field of displays, and in particular to a display panel and a manufacturing method thereof.

### BACKGROUND OF THE INVENTION

The traditional display panel has a black matrix layer for preventing a light leakage problem.

Due to the liquid crystal molecules not being deflected normally, or different electric fields being formed between two pixels by loading different signals confusing the deflection direction of the liquid crystal molecules, the light leakage problem is shown from an area which the electric field of the pixel electrodes does not cover.

In practice, the following problem exists in the current art:

The black matrix layer is disposed in the traditional display panel, but the effect for preventing the light leakage is still not good enough.

Therefore, a new display panel and a new manufacturing method need to be developed which solve the problems existing in the conventional art as described above.

### SUMMARY OF THE INVENTION

A primary object of the present invention is to provide a display panel and a manufacturing method thereof, which prevents the light leakage of the display panel.

To achieve the above object, the present invention provides a display panel which comprises a first display area, a second display area, and a non-display area disposed between the first display area and the second display area, and the display panel comprises a first panel, a second panel and a liquid crystal layer. The first panel comprises a first base; an element arrayed layer disposed on the first base and having thin film transistor switches, data lines, scan lines, and pixel electrodes; a color film disposed on the element arrayed layer and having a first color barrier corresponding to the first display area, and a second color barrier corresponding to the second display area; and a first light shielding layer disposed on the element arrayed layer and having a first light shielding block corresponding to the non-display area. The second panel comprises a second base; and a second light shielding layer disposed on the second base and having a second light shielding block corresponding to the non-display area. The second light shielding block is a black photo spacer connected to the first light shielding block. The first panel and second panel are spaced from the second light shielding block and the first light shielding block, and the second light shielding block and the first light shielding block are shielded from a through light, the through light is emitted from the first display area to the second display area, or emitted from the second display area to the first display area. The liquid crystal layer is disposed between the first base and the second base. The first color barrier is a color barrier of the red, green, or blue colored barriers, and the second color barrier is another color barrier of the red, green, or blue colored barriers; the first color barrier has a first extending portion disposed in the non-display area, and the second color barrier has a second extending portion disposed in the non-display area, the first light shielding block is formed by stacking the first extending portion and the second extending portion.

In one embodiment of the present invention, a thickness of the first extending portion is less than a thickness of the first color barrier, the first extending portion is formed by implementing a first mask process on a first color barrier material layer, and the first color barrier material layer corresponds to the first color barrier in the first display area; and/or a thickness of the second extending portion is less than a thickness of the second color barrier, the second extending portion is formed by implementing a second mask process on a second color barrier material layer, and the second color barrier material layer corresponds to the second color barrier in the second display area.

In one embodiment of the present invention, a first mask of the first mask process comprises a first area corresponding to the first display area or the second display area, and a second area corresponding to the non-display area, and the first area has a first transmittance and the second area has a second transmittance; a second mask of the second mask process comprises a third area corresponding to the first display area or the second display area, and a fourth area corresponding to the non-display area, and the third area has a third transmittance and the fourth area has a fourth transmittance.

In one embodiment of the present invention, the first color barrier is a red colored barrier, and the second color barrier is a blue colored barrier.

To achieve the above object, the present invention provides a display panel which comprises a first display area, a second display area, and a non-display area disposed between the first display area and the second display area, and the display panel comprises a first panel, a second panel, and a liquid crystal layer. The first panel comprises a first base; an element arrayed layer disposed on the first base and having thin film transistor switches, data lines, scan lines, and pixel electrodes; a color film disposed on the element arrayed layer and having a first color barrier corresponding to the first display area, and a second color barrier corresponding to the second display area; and a first light shielding layer disposed on the element arrayed layer and having a first light shielding block corresponding to the non-display area. The second panel has a second base; and a second light shielding layer disposed on the second base and having a second light shielding block corresponding to the non-display area. The liquid crystal layer is disposed between the first base and the second based.

In one embodiment of the present invention, the first color barrier is a color barrier of the red, green, or blue colored barriers, and the second color barrier is another color barrier of the red, green, or blue colored barriers; the first color barrier has a first extending portion disposed in the non-display area, and the second color barrier has a second extending portion disposed in the non-display area, the first light shielding block is formed by stacking the first extending portion and the second extending portion.

In one embodiment of the present invention, a thickness of the first extending portion is less than a thickness of the first color barrier, the first extending portion is formed by implementing a first mask process on a first color barrier material layer, and the first color barrier material layer corresponds to the first color barrier in the first display area; and/or a thickness of the second extending portion is less than a thickness of the second color barrier, the second extending portion is formed by implementing a second mask process on a second color barrier material layer, and the second color barrier material layer corresponds to the second color barrier in the second display area.

In one embodiment of the present invention, a first mask of the first mask process comprises a first area corresponding to the first display area or the second display area, and a second area corresponding to the non-display area, and the first area has a first transmittance and the second area has a second transmittance; a second mask of the second mask process comprises a third area corresponding to the first display area or the second display area, and a fourth area corresponding to the non-display area, and the third area has a third transmittance and the fourth area has a fourth transmittance.

In one embodiment of the present invention, the fourth area is formed by interlacing a light-transmitting area and a light-blocking region, the fourth transmittance is equal to an area ratio of the light-transmitting area and the light-blocking region.

In one embodiment of the present invention, the first mask and the second mask are one of the half tone mask or the gray tone mask.

In one embodiment of the present invention, the second light shielding block is a black photo spacer connected to the first light shielding block; the first panel and second panel are spaced from the second light shielding block and the first light shielding block, and the second light shielding block and the first light shielding block are shielded from a through light, the through light is emitted from the first display area to the second display area, or emitted from the second display area to the first display area.

In one embodiment of the present invention, the first display area and the second display area correspond to the pixel electrodes of the display panel, and the non-display area corresponds to the data lines and the scan lines of the display panel.

To achieve the above object, the present invention provides a display panel manufacturing method which comprises steps of: (A) forming a first panel and a second panel, wherein the first panel comprises a first base, an element arrayed layer, a color film, and a first light shielding layer, the color film has a first color barrier corresponding to a first display area, and a second color barrier corresponding to a second display area, the first light shielding layer has a first light shielding block corresponding to a non-display area, the second panel comprises a second base and a second light shielding layer, the second light shielding layer has a second light shielding block corresponding to the non-display area; and (B) overlapping the first panel on the second panel, and disposing a liquid crystal layer between the first panel and the second panel, wherein the first light shielding block connects to the second light shielding block, and the first panel and second panel are spaced from the second light shielding block and the first light shielding block, and the second light shielding block and the first light shielding block are shielded from a through light, the through light is emitted from the first display area to the second display area, or emitted from the second display area to the first display area.

In one embodiment of the present invention, the step (A) comprises steps of: (a1)) forming the element arrayed layer on the first base, wherein the element arrayed layer has thin film transistor switches, data lines, scan lines, and pixel electrodes; and (a2) forming the color film and the first light shielding layer on the element arrayed layer, wherein the first color barrier is a color barrier of the red, green, or blue colored barriers, and the second color barrier is another color barrier of the red, green, or blue colored barriers; the first color barrier has a first extending portion disposed in the non-display area, and the second color barrier has a second extending portion disposed in the non-display area, the first light shielding block is formed by stacking the first extending portion and the second extending portion.

In one embodiment of the present invention, a thickness of the first extending portion is less than a thickness of the first color barrier; and/or a thickness of the second extending portion is less than a thickness of the second color barrier, the step (a2) comprising steps of: (a21) forming a first color barrier material layer on the element arrayed layer, and implementing a first mask process on the first color barrier material layer located in the non-display area to form the first extending portion, wherein the first color barrier material layer covers the first display area and the non-display area, and corresponds to the first color barrier in the first display area; and/or (a22) forming a second color barrier material layer on the element arrayed layer, and implementing a second mask process on the second color barrier material layer located in the non-display area to form the second extending portion, wherein the second color barrier material layer covers the second display area and the non-display area, and corresponds to the second color barrier in the second display area.

In one embodiment of the present invention, a first mask of the first mask process comprises a first area corresponding to the first display area or the second display area, and a second area corresponding to the non-display area, and the first area has a first transmittance and the second area has a second transmittance; a second mask of the second mask process comprises a third area corresponding to the first display area or the second display area, and a fourth area corresponding to the non-display area, and the third area has a third transmittance and the fourth area has a fourth transmittance.

In one embodiment of the present invention, the fourth area is formed by interlacing a light-transmitting area and a light-blocking region, the fourth transmittance is equal to an area ratio of the light-transmitting area and the light-blocking region.

In one embodiment of the present invention, the first mask and the second mask are one of the half tone mask or the gray tone mask.

In one embodiment of the present invention, the step (A) further comprises a step of: (a3) forming the second light shielding layer on the second base, wherein the second light shielding layer has at least two second light shielding blocks corresponding to the non-display area, and the second light shielding blocks are black photo spacers.

In one embodiment of the present invention, the first display area and the second display area correspond to the pixel electrodes of the display panel, and the non-display area corresponds to the data lines and the scan lines of the display panel.

Compared with the prior art, the present invention can prevent the light leakage of the display panel.

The present invention is described in detail below by way of specific embodiments in conjunction with the accompanying drawings.

### DESCRIPTION OF THE DRAWINGS

FIG. 1 is a schematic view of a display panel of the present invention;

FIGS. 2 to 8 are schematic views of a manufacturing method for a first panel of the display panel of the present invention;

FIG. 9 is a schematic vies of a first mask;

FIG. 10 is a schematic vies of a second mask;

FIG. 11 is a flowchart of a first embodiment of the display panel manufacturing method of the present invention;

FIG. 12 is a flowchart of a second embodiment of the display panel manufacturing method of the present invention; and

FIG. 13 is a flowchart of a third embodiment of the display panel manufacturing method of the present invention.

### DETAILED DESCRIPTION OF THE PREFERRED EMBODIMENTS

Regarding the words used in the present specification, “an embodiment” means used as an example, examples, or illustrations. In addition, in this specification and the appended claims the article “a” in general can be interpreted to mean “one or more” unless specified otherwise or clear from the context to be oriented to the singular form.

The display panel of the present invention is a thin film transistor liquid crystal display.

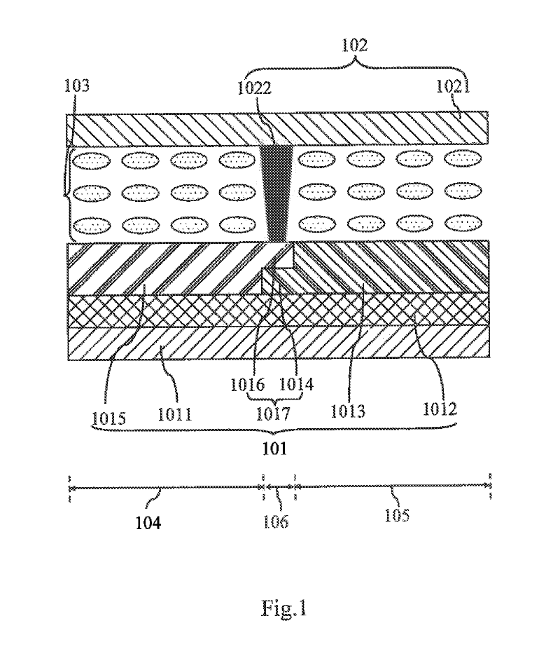

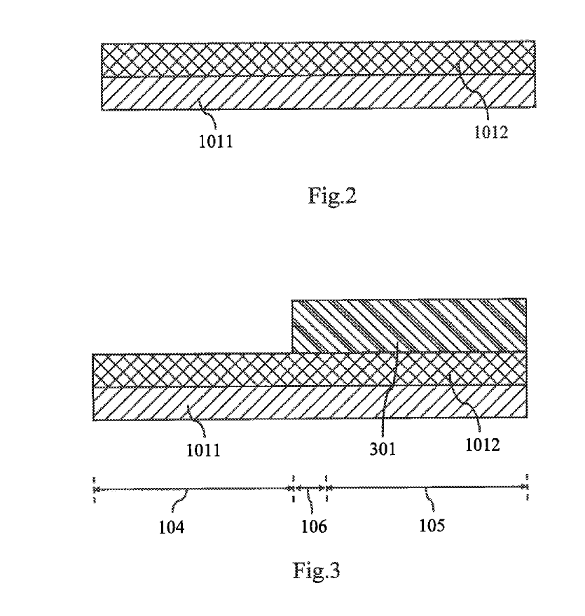

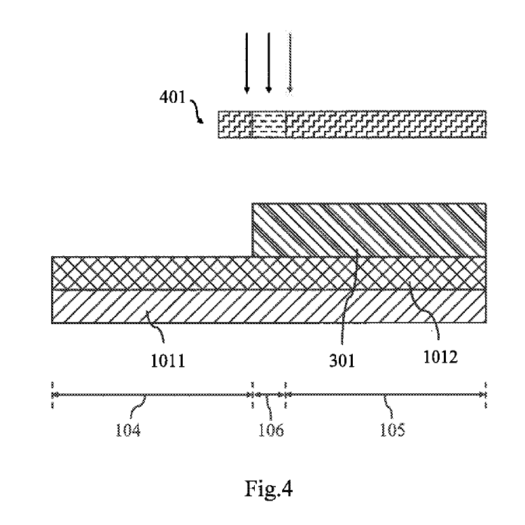

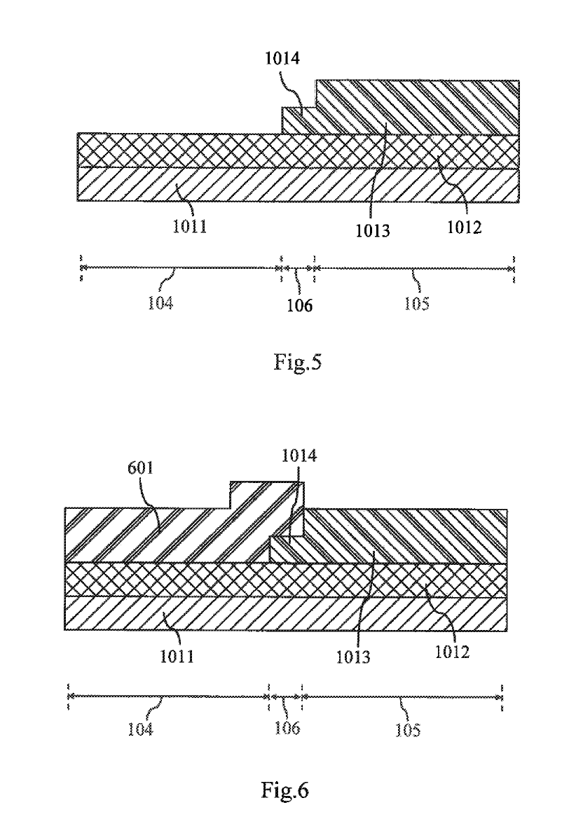

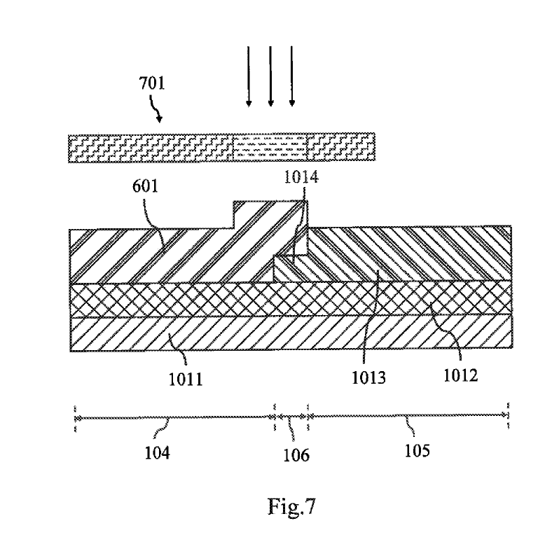

Refer to FIGS. 1 to 8, FIG. 1 is a schematic view of a display panel of the present invention, and FIGS. 2 to 8 are schematic views of a manufacturing method for a first panel 101 of the display panel of the present invention.

The display panel of the present invention has a first display area 105, a second display area 104, and a non-display area 106. The non-display area 106 is disposed between the first display area 105 and the second display area 104. The first display area 105 and the second display area 104 correspond to the pixel electrodes of the display panel, and the non-display area 106 corresponds to data lines and scan lines of the display panel.

The display panel has a first panel 101, a second panel 102 and a liquid crystal layer 103. The first panel 101 is overlapped on the second panel 102 to form a liquid crystal cell, and the liquid crystal layer 103 is disposed in the liquid crystal cell between the first panel 101 and the second panel 102.

The first panel 101 comprises a first base 1011, an element arrayed layer 1012, a color film, and a first light shielding layer. The element arrayed layer 1012 is disposed on the first base 1011, and the element arrayed layer 1012 has thin film transistor switches, data lines, scan lines, and pixel electrodes. The color film is disposed on the element arrayed layer 1012, and the color film has a first color barrier 1013 and a second color barrier 1015. The first color barrier 1013 corresponds to the first display area 105, and the second color barrier 1015 corresponds to the second display area 104. The first light shielding layer is disposed on the element arrayed layer 1012. The first light shielding layer has a first light shielding block 1017, and the first light shielding block 1017 corresponds to the non-display area 106.

The second panel 102 comprises a second base 1021 and a second light shielding layer. The second light shielding layer has a second light shielding block 1022, and the second light shielding block 1022 corresponds to the non-display area 106.

In the embodiment, the first color barrier 1013 is a color barrier of the red, green or blue colored barriers, and the second color barrier 1015 is another color barrier of the red, green, or blue colored barriers.

The first color barrier 1013 has a first extending portion 1014, and the second color barrier 1015 has a second extending portion 1016. The first extending portion 1014 and the second extending portion 1016 are disposed in the non-display area 106.

The first light shielding block 1017 is formed by stacking the first extending portion 1014 and the second extending portion 1016.

In the embodiment, there are three kinds of the thickness of the first extending portion 1017, and the first extending portion 1017 is also formed in three types.

Type 1:

A thickness of the first extending portion 1014 is less than a thickness of the first color barrier 1013. The first extending portion 1014 is formed by implementing a first mask process on a first color barrier material layer 301. The first color barrier material layer 301 corresponds to the first color barrier 1013 in the first display area 105.

At this time, a thickness of the second extending portion 1016 is not implemented a reducing thickness process, thus the thickness of the second extending portion 1016 is equal to a thickness of a second color barrier material layer 601 in the non-display area 106. A thickness of the first light shielding block 1017 is equal to the sum of the thickness of the first extending portion 1014 and the thickness of the second color barrier material layer 601 in the non-display area 106.

Type 2:

A thickness of the second extending portion 1016 is less than a thickness of the second color barrier 1015. The second extending portion 1016 is formed by implementing a second mask process on the second color barrier material layer 601. The second color barrier material layer 601 corresponds to the second color barrier 1015 in the second display area 104.

In this embodiment, a thickness of the first extending portion 1014 is not implemented in a reducing thickness process, thus the thickness of the first extending portion 1014 is equal to a thickness of the first color barrier material layer 301 in the non-display area 106. A thickness of the first light shielding block 1017 is equal to the sum of the thickness of the second extending portion 1016 and the thickness of the first color barrier material layer 301 in the non-display area 106.

Type 3:

The thickness of the first extending portion 1014 is less than the thickness of the first color barrier 1013, and the thickness of the second extending portion 1016 is less than the thickness of the second color barrier 1015.

The first extending portion 1014 is formed by implementing the first mask process on the first color barrier material layer 301. The first color barrier material layer 301 corresponds to the first color barrier 1013 in the first display area 105.

The second extending portion 1016 is formed by implementing the second mask process on the second color barrier material layer 601. The second color barrier material layer 601 corresponds to the second color barrier 1015 in the second display area 104.

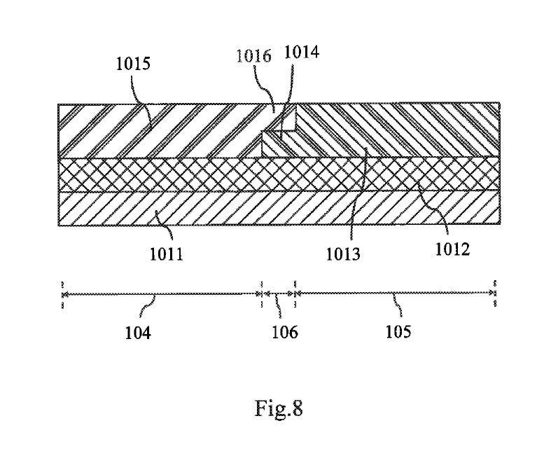

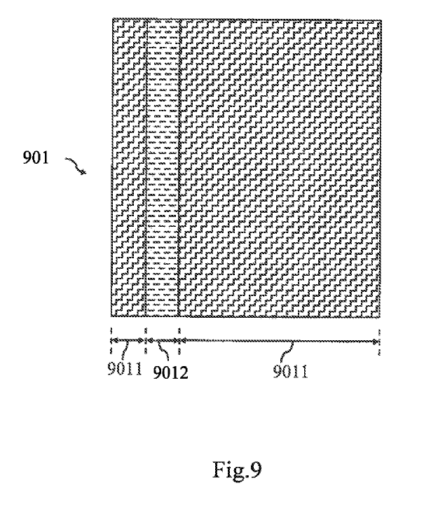

Refer to FIG. 8, in this embodiment, the thickness of the first light shielding block 1017 is equal to the sum of the thickness of the first extending portion 1014 and the thickness of the second extending portion 1016.

In the embodiment, the mask 401, 701 of the first and the second mask processes are the first mask 901 and the second mask 1001, respectively.

Refer to FIG. 9, the first mask 901 has a first area 9011 and a second area 9012. The first area 9011 corresponds to the first display area 105 or the second display area 104. The second area 9012 corresponds to the the non-display area 106. The first area 9011 has a first transmittance, and the second area 9012 has a second transmittance.

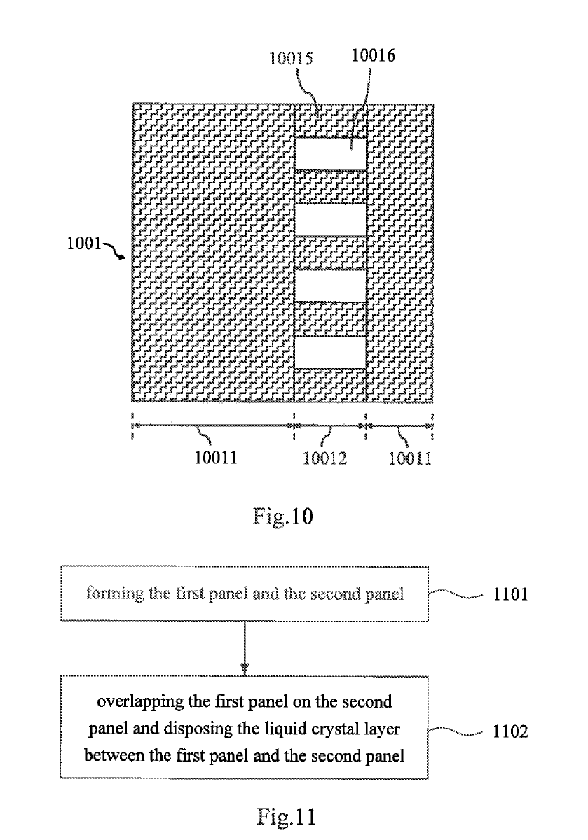

Refer to FIG. 10, the second mask 1001 has a third area 10011 and a fourth area 10012. The third area 10011 corresponds to the first display area 105 or the second display area 104. The fourth area 10012 corresponds to the non-display area 106. The third area 10011 has a third transmittance and the fourth area 11012 has a fourth transmittance. The fourth area 10012 is formed by interlacing a light-transmitting area 10016 and a light-blocking region 10015. The fourth transmittance is equal to an area ratio of the light-transmitting area 10016 and the light-blocking region 10015.

The first mask 901 and the second mask 1001 are preferably one of the half tone mask or the gray tone mask.

In the embodiment, the second light shielding block 1022 is a black photo spacer, and the second light shielding block 1022 connects to the first light shielding block 1017.

The first panel 101 and second panel 102 are spaced from the second light shielding block 1022 and the first light shielding block 1017, and the second light shielding block 1022 and the first light shielding block 1017 are shielded from a through light. The through light is emitted from the first display area 105 to the second display area 104, or emitted from the second display area 104 to the first display area 105.

In the embodiment, the first extending portion 1014 of the first color barrier 1013 and the second extending portion 1016 of the second color barrier 1015 are overlapped to form the first light shielding block 1017. The first color barrier 1013 and the second color barrier 1015 are any two color barriers of the red, green, or blue colored barriers. Thus the first light shielding block 1017 is shielded from the light. Furthermore, the thickness of the first color barrier 1013 and the thickness of the second color barrier 1015 are reduced at the non-display area 106, and the thickness of the first extending portion 1014 and/or the second extending portion 1016 are reduced. Thus, the sum of the thickness of the first extending portion 1014 and the thickness of the second extending portion 1016 is less than the sum of the thickness of the first color barrier material layer 301 and the thickness of the second color barrier material layer 601. When an interval is kept between the first panel 101 and the second panel 102, the thickness of the first light shielding block 1017 is reduced and the thickness of the second light shielding block 1022 is increased. In other words, the liquid crystal cell has enough space to receive the second light shielding block 1022 without a planarization layer. The shading effect of the first light shielding block 1017 and the second light shielding block 1022 can be increased (the shading effect is worse by thinning the thickness of the second light shielding block 1022). Therefore, the present invention can prevent the light leakage of the display panel.

The first light shielding block 1017 is implemented to shield the light, and the active principle is described as follows:

When the first color barrier 1013 is a red colored barrier, and the second color barrier 1015 is a blue colored barrier. The first extending portion 1014 is formed from a red colored resistive material, and the second extending portion 1016 is formed from a blue colored resistive material. The light is emitted to the first extending portion 1014 (red colored resistive material), and a red light penetrates the the first extending portion 1014, and a blue light and a green light are absorbed by the first extending portion 1014. The red light is emitted to the second extending portion 1016 (blue colored resistive material) from the first extending portion 1014, and the red light is absorbed by the second extending portion 1016. In other words, the light can be absorbed (shielded) by combining the first extending portion 1014 and the second extending portion 1016. Therefore, the present invention can prevent the light leakage problem of the display panel.

Refer to FIG. 11, which is a flowchart of a first embodiment of the display panel manufacturing method of the present invention.

A display panel manufacturing method of the present invention comprises steps of:

In step 1101, forming a first panel 101 and a second panel 102. Wherein the first panel 101 comprises a first base 1011, an element arrayed layer 1012, a color film, and a first light shielding layer. The color film has a first color barrier 1013, and a second color barrier 1015. The first color barrier 1013 corresponds to a first display area 105, and the second color barrier 1015 corresponds to a second display area 104. The first light shielding layer has a first light shielding block 1017, and the first light shielding block 1017 corresponds to a non-display area 106. The second panel 102 comprises a second base 1021 and a second light shielding layer, the second light shielding layer has a second light shielding block 1022, and the second light shielding block 1022 corresponds to the non-display area 106.

In step 1102, overlapping the first panel 101 on the second panel 102, and disposing a liquid crystal layer 103 between the first panel 101 and the second panel 102. Wherein the first light shielding block 1017 connects to the second light shielding block 1022. The first panel 101 and second panel 102 are spaced from the second light shielding block 1022 and the first light shielding block 1017, and the second light shielding block 1022 and the first light shielding block 1017 shielded from a through light. The through light is emitted from the first display area 105 to the second display area 104, or emitted from the second display area 104 to the first display area 105.

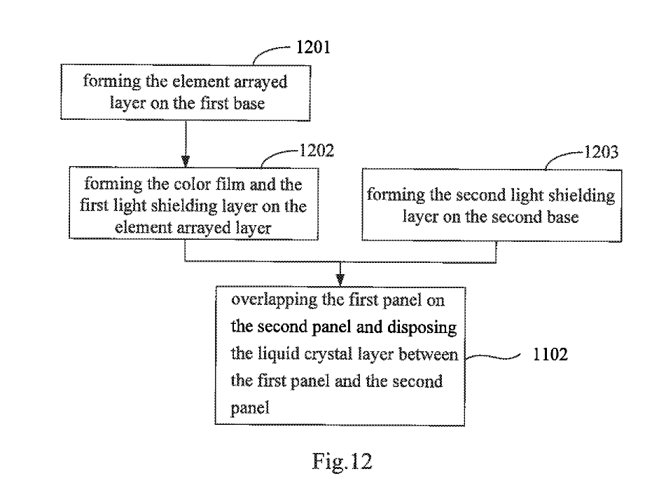

Refer to FIGS. 2 to 8 and FIG. 12, FIG. 12 is a flowchart of a second embodiment of the display panel manufacturing method of the present invention. The second embodiment is similar to the first embodiment, and the difference between the two embodiments is as follows:

In the second embodiment, the step 1101 comprises sub-steps for forming the first panel 101, and the sub-steps are as follows:

In step 1201, forming the element arrayed layer 1012 on the first base 1011, wherein the element arrayed layer 1012 has thin film transistor switches, data lines, scan lines, and pixel electrodes.

In step 1202, forming the color film and the first light shielding layer on the element arrayed layer 1012, wherein the first color barrier 1013 is a color barrier of the red, green, or blue colored barriers, and the second color barrier 1015 is another color barrier of the red, green, or blue colored barriers. The first color barrier 1013 has a first extending portion 1014, and the second color barrier 1015 has a second extending portion 1016. The first extending portion 1014 and the second extending portion 1016 are disposed in the non-display area 106. The first light shielding block 1017 is formed by stacking the first extending portion 1014 and the second extending portion 1016.

In the embodiment, the step 1101 further comprises sub-steps for forming the second panel 102, and the sub-steps as follows:

In step 1203, forming the second light shielding layer on the second base 1021, wherein the second light shielding layer has at least two second light shielding blocks 1022, and the second light shielding blocks 1022 corresponds to the non-display area 106. The second light shielding blocks are black photo spacers.

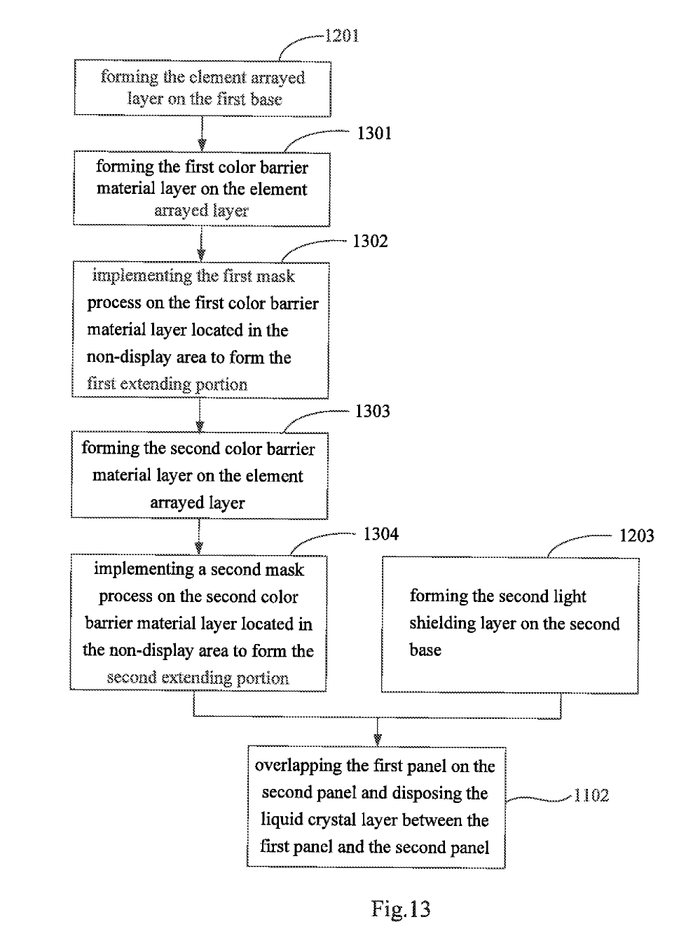

Refer to FIG. 13, which is a flowchart of a third embodiment of the display panel manufacturing method of the present invention. The third embodiment is similar to the second embodiment, and the difference between the two embodiments as follows:

In the third embodiment, there are three kinds of thickness of the first extending portion 1017, and the first extending portion 1017 is also formed in three types.

Type 1:

A thickness of the first extending portion 1014 is less than a thickness of the first color barrier 1013.

In this case, the sub-steps are explained as follows:

In the steps 1301 and 1302, forming a first color barrier material layer 301 on the element arrayed layer 1012, and implementing a first mask process on the first color barrier material layer located in the non-display area 106 to form the first extending portion 1014, wherein the first color barrier material layer 301 covers the first display area 105 and the non-display area 106. The first color barrier material layer 301 corresponds to the first color barrier 1013 in the first display area 105.

In this embodiment, a thickness of the second extending portion 1016 is not implemented in a reducing thickness process, thus the thickness of the second extending portion 1016 is equal to a thickness of a second color barrier material layer 601 in the non-display area 106. A thickness of the first light shielding block 1017 is equal to the sum of the thickness of the first extending portion 1014 and the thickness of the second color barrier material layer 601 in the non-display area 106.

Type 2:

A thickness of the second extending portion 1016 is less than a thickness of the second color barrier 1015.

In this case, the sub-steps are explained as follows:

In the steps 1303 and 1304, forming a second color barrier material layer 601 on the element arrayed layer 1012, and implementing a second mask process on the second color barrier material layer 601 located in the non-display area 106 to form the second extending portion 1016, wherein the second color barrier material layer 601 covers the second display area 104 and the non-display area 106, and the second color barrier material layer 601 corresponds to the second color barrier 1015 in the second display area 104.

In this embodiment, a thickness of the first extending portion 1014 is not implemented in a reducing thickness process, thus the thickness of the first extending portion 1014 is equal to a thickness of the first color barrier material layer 301 in the non-display area 106. A thickness of the first light shielding block 1017 is equal to the sum of the thickness of the second extending portion 1016 and the thickness of the first color barrier material layer 301 in the non-display area 106.

Type 3:

The thickness of the first extending portion 1014 is less than the thickness of the first color barrier 1013, and the thickness of the second extending portion 1016 is less than the thickness of the second color barrier 1015.

In this case, the sub-steps are explained as follows:

In the steps 1301 and 1302, forming a first color barrier material layer 301 on the element arrayed layer 1012, and implementing a first mask process on the first color barrier material layer located in the non-display area 106 to form the first extending portion 1014, wherein the first color barrier material layer 301 covers the first display area 105 and the non-display area 106. The first color barrier material layer 301 corresponds to the first color barrier 1013 in the first display area 105.

In the steps 1303 and 1304, forming a second color barrier material layer 601 on the element arrayed layer 1012, and implementing a second mask process on the second color barrier material layer 601 located in the non-display area 106 to form the second extending portion 1016, wherein the second color barrier material layer 601 covers the second display area 104 and the non-display area 106, and the second color barrier material layer 601 corresponds to the second color barrier 1015 in the second display area 104.

Refer to FIG. 8. in this embodiment, the thickness of the first light shielding block 1017 is equal to the sum of the thickness of the first extending portion 1014 and the thickness of the second extending portion 1016.

In the embodiment, the mask 401, 701 of the first and the second mask processes are the first mask 901 and the second mask 1001, respectively.

Refer to FIG. 9, the first mask 901 has a first area 9011 and a second area 9012. The first area 9011 corresponds to the first display area 105 or the second display area 104. The second area 9012 corresponds to the the non-display area 106. The first area 9011 has a first transmittance, and the second area 9012 has a second transmittance.

Refer to FIG. 10, the second mask 1001 has a third area 10011 and a fourth area 10012. The third area 10011 corresponds to the first display area 105 or the second display area 104. The fourth area 10012 corresponds to the non-display area 106. The third area 10011 has a third transmittance and the fourth area 11012 has a fourth transmittance.

The first mask 901 and the second mask 1001 are preferably one of the half tone mask or the gray tone mask.

In the embodiment, the first extending portion 1014 of the first color barrier 1013 and the second extending portion 1016 of the second color barrier 1015 are overlapped to form the first light shielding block 1017. The first color barrier 1013 and the second color barrier 1015 are any two color barriers of the red, green, or blue colored barriers. Thus the first light shielding block 1017 is shielded from the light. Furthermore, the thickness of the first color barrier 1013 and the thickness of the second color barrier 1015 are reduced in the non-display area 106, and the thickness of the first extending portion 1014 and/or the second extending portion 1016 are reduced. Thus, the sum of the thickness of the first extending portion 1014 and the thickness of the second extending portion 1016 is less than the sum of the thickness of the first color barrier material layer 301 and the thickness of the second color barrier material layer 601. When an interval is kept between the first panel 101 and the second panel 102, the thickness of the first light shielding block 1017 is reduced and the thickness of the second light shielding block 1022 is increased. In other words, the liquid crystal cell has an enough space to receive the second light shielding block 1022 without a planarization layer. The shading effect of the first light shielding block 1017 and the second light shielding block 1022 can be increased (the shading effect is made worse by decreasing the thickness of the second light shielding block 1022).

The first light shielding block 1017 is implemented to shield the light, and the active principle is described as follows:

When the first color barrier 1013 is a red colored barrier and the second color barrier 1015 is a blue colored barrier, the first extending portion 1014 is formed from a red colored resistive material, and the second extending portion 1016 is formed from a blue colored resistive material. The light is emitted to the first extending portion 1014 (red colored resistive material), and a red light penetrates the the first extending portion 1014, and a blue light and a green light is absorbed by the first extending portion 1014. The red light is emitted to the second extending portion 1016 (blue colored resistive material) from the first extending portion 1014, and the red light is absorbed by the second extending portion 1016. In other words, the light can be absorbed (shielded) by combining the first extending portion 1014 and the second extending portion 1016. Therefore, the present invention can prevent the light leakage of the display panel.

Moreover, despite relative to one or more implementations shown and described the present disclosure, various equivalent modifications will occur to those skilled in the art based on the present specification and drawings. The present disclosure includes all such modifications and variations, and is only limited by the scope of the appended claims. Particularly, with regard to various functions performed by the above-described components (e.g., elements, resources, etc.), the terms used to describe such components are intended to perform the function corresponding to the specified component (e.g., which is functionally equivalent) of any component (unless otherwise indicated), even if the structure of the implementation and execution of the function of the present disclosure is not structurally equivalent. Additionally, although a particular feature of the present disclosure has been made with respect to certain implementations, only one is open, but this feature may be as given or particular application and the purpose of enabling a desired one or more other implementations Other combinations of features. Moreover, the terms “comprising,” “having,” “containing,” or variants thereof as used in the detailed description or the claims are intended to be used in a manner similar to the term “comprising”.

The present invention has been described with preferred embodiments thereof and it is understood that many changes and modifications to the described embodiments can be carried out without departing from the scope and the spirit of the invention that is intended to be limited only by the appended claims.

What is claimed is:

1. A display panel having a first display area, a second display area, and a non-display area disposed between the first display area and the second display area, and the display panel comprising:
a first panel comprising:
a first base;
an element arrayed layer disposed on the first base and having thin film transistor switches, data lines, scan lines, and pixel electrodes;
a color film disposed on the element arrayed layer and having a first color barrier corresponding to the first display area, and a second color barrier corresponding to the second display area; and
a first light shielding layer disposed on the element arrayed layer and having a first light shielding block corresponding to the non-display area;
a second panel comprising:
a second base; and
a second light shielding layer disposed on the second base and having a second light shielding block corresponding to the non-display area, wherein the second light shielding block is a black photo spacer connected to the first light shielding block;
wherein the first panel and second panel are spaced from the second light shielding block and the first light shielding block, and the second light shielding block and the first light shielding block are shielded from a through light, the through light is emitted from the first display area to the second display area, or emitted from the second display area to the first display area; and
a liquid crystal layer disposed between the first base and the second base;
wherein the first color barrier is a color barrier of the red, green, or blue colored barriers, and the second color barrier is another color barrier of the red, green, or blue colored barriers; the first color barrier has a first extending portion disposed in the non-display area, and the second color barrier has a second extending portion disposed in the non-display area, the first light shielding block is formed by stacking the first extending portion and the second extending portion.

2. The display panel according to claim 1, wherein a thickness of the first extending portion is less than a thickness of the first color barrier, the first extending portion is formed by implementing a first mask process on a first color barrier material layer, and the first color barrier material layer corresponds to the first color barrier in the first display area; and/or a thickness of the second extending portion is less than a thickness of the second color barrier, the second extending portion is formed by implementing a second mask process on a second color barrier material layer, and the second color barrier material layer corresponds to the second color barrier in the second display area.

3. The display panel according to claim 2, wherein a first mask of the first mask process comprises a first area corresponding to the first display area or the second display area, and a second area corresponding to the non-display area, and the first area has a first transmittance and the second area has a second transmittance;
a second mask of the second mask process comprises a third area corresponding to the first display area or the second display area, and a fourth area corresponding to the non-display area, and the third area has a third transmittance and the fourth area has a fourth transmittance.

4. The display panel according to claim 1, wherein the first color barrier is a red colored barrier, and the second color barrier is a blue colored barrier.

5. A display panel having a first display area, a second display area, and a non-display area disposed between the first display area and the second display area, and the display panel comprising:
a first panel comprising:
a first base;
an element arrayed layer disposed on the first base and having thin film transistor switches, data lines, scan lines, and pixel electrodes;
a color film disposed on the element arrayed layer and having a first color barrier corresponding to the first display area, and a second color barrier corresponding to the second display area; and
a first light shielding layer disposed on the element arrayed layer and having a first light shielding block corresponding to the non-display area;
a second panel comprising:
a second base; and
a second light shielding layer disposed on the second base and having a second light shielding block corresponding to the non-display area; and
a liquid crystal layer disposed between the first base and the second base.

6. The display panel according to claim 5, wherein the first color barrier is a color barrier of the red, green, or blue colored barriers, and the second color barrier is another color barrier of the red, green, or blue colored barriers; the first color barrier has a first extending portion disposed in the non-display area, and the second color barrier has a second extending portion disposed in the non-display area, the first light shielding block is formed by stacking the first extending portion and the second extending portion.

7. The display panel according to claim 6, wherein a thickness of the first extending portion is less than a thickness of the first color barrier, the first extending portion is formed by implementing a first mask process on a first color barrier material layer, and the first color barrier material layer corresponds to the first color barrier in the first display area; and/or a thickness of the second extending portion is less than a thickness of the second color barrier, the second extending portion is formed by implementing a second mask process on a second color barrier material layer, and the second color barrier material layer corresponds to the second color barrier in the second display area.

8. The display panel according to claim 7, wherein a first mask of the first mask process comprises a first area corresponding to the first display area or the second display area, and a second area corresponding to the non-display area, and the first area has a first transmittance and the second area has a second transmittance;
a second mask of the second mask process comprises a third area corresponding to the first display area or the second display area, and a fourth area corresponding to the non-display area, and the third area has a third transmittance and the fourth area has a fourth transmittance.

9. The display panel according to claim 8, wherein the fourth area is formed by interlacing a light-transmitting area and a light-blocking region, the fourth transmittance is equal to an area ratio of the light-transmitting area and the light-blocking region.

10. The display panel according to claim 8, wherein the first mask and the second mask are one of a half tone mask or a gray tone mask.

11. The display panel according to claim 5, wherein the second light shielding block is a black photo spacer connected to the first light shielding block;
the first panel and second panel are spaced from the second light shielding block and the first light shielding block, and the second light shielding block and the first light shielding block are shielded from a through light, the through light is emitted from the first display area to the second display area, or emitted from the second display area to the first display area.

12. The display panel according to claim 5, wherein the first display area and the second display area correspond to the pixel electrodes of the display panel, and the non-display area corresponds to the data lines and the scan lines of the display panel.

13. A display panel manufacturing method according to claim 5, the method comprising steps of:
(A) forming a first panel and a second panel, wherein the first panel comprises a first base, an element arrayed layer, a color film, and a first light shielding layer, the color film has a first color barrier corresponding to a first display area, and a second color barrier corresponding to a second display area, the first light shielding layer has a first light shielding block corresponding to a non-display area, the second panel comprises a second base and a second light shielding layer, the second light shielding layer has a second light shielding block corresponding to the non-display area; and
(B) overlapping the first panel on the second panel, and disposing a liquid crystal layer between the first panel and the second panel, wherein the first light shielding block connects to the second light shielding block, and the first panel and second panel are spaced from the second light shielding block and the first light shielding block, and the second light shielding block and the first light shielding block are shielded from a through light, the through light is emitted from the first display area to the second display area, or emitted from the second display area to the first display area.

14. The method according to claim 13, wherein the step (A) comprises steps of:
(a1)) forming the element arrayed layer on the first base, wherein the element arrayed layer has thin film transistor switches, data lines, scan lines, and pixel electrodes; and
(a2) forming the color film and the first light shielding layer on the element arrayed layer, wherein the first color barrier is a color barrier of the red, green, or blue colored barriers, and the second color barrier is another color barrier of the red, green or blue colored barriers; the first color barrier has a first extending portion disposed in the non-display area, and the second color barrier has a second extending portion disposed in the non-display area, the first light shielding block is formed by stacking the first extending portion and the second extending portion.

15. The method according to claim 14, wherein a thickness of the first extending portion is less than a thickness of the first color barrier; and/or a thickness of the second extending portion is less than a thickness of the second color barrier, the step (a2) comprising steps of:
(a21) forming a first color barrier material layer on the element arrayed layer, and implementing a first mask process on the first color barrier material layer located in the non-display area to form the first extending portion, wherein the first color barrier material layer covers the first display area and the non-display area, and corresponds to the first color barrier in the first display area; and/or
(a22) forming a second color barrier material layer on the element arrayed layer, and implementing a second mask process on the second color barrier material layer located in the non-display area to form the second extending portion, wherein the second color barrier material layer covers the second display area and the non-display area, and corresponds to the second color barrier in the second display area.

16. The method according to claim 15, wherein a first mask of the first mask process comprises a first area corresponding to the first display area or the second display area, and a second area corresponding to the non-display area, and the first area has a first transmittance and the second area has a second transmittance;
a second mask of the second mask process comprises a third area corresponding to the first display area or the second display area, and a fourth area corresponding to the non-display area, and the third area has a third transmittance and the fourth area has a fourth transmittance.

17. The method according to claim 16, wherein wherein the fourth area is formed by interlacing a light-transmitting area and a light-blocking region, the fourth transmittance is equal to an area ratio of the light-transmitting area and the light-blocking region.

18. The method according to claim 16, wherein the first mask and the second mask are one of a half tone mask or a gray tone mask.

19. The method according to claim 13, wherein the step (A) further comprises a step of:
(a3) forming the second light shielding layer on the second base, wherein the second light shielding layer has at least two second light shielding blocks corresponding to the non-display area, and the second light shielding blocks are black photo spacers.

20. The method according to claim 13, wherein the first display area and the second display area correspond to the pixel electrodes of the display panel, and the non-display area corresponds to the data lines and the scan lines of the display panel.
